(19) United States
(12) Patent Application Publication
(10) Pub. No.: US 2005/0036475 A1
(43) Pub. Date: Feb. 17, 2005

(54) Wireless communication apparatus, wireless communication method, and computer program

(75) Inventors: Fumihiro Nishiyama, Saitama (JP); Hidemasa Yoshida, Chiba (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/864,537

(22) Filed: Jun. 10, 2004

(30) Foreign Application Priority Data
Jun. 24, 2003 (JP) 2003-179507

(51) Int. Cl. H04B 7/212

(52) U.S. Cl. 370/347; 370/349; 455/516

(57) ABSTRACT

Communication bands are effectively allocated to each communication station under a communication environment of an autonomous distributed type system such as an ad-hoc communication. Each communication station acquires a priority slot with which each communication station itself performs data transmission preferentially at predetermined time intervals, and releases or allocates its own priority slot to other communication station in response to a permission form upper layer of a communication protocol based on a fact that the transmission data is not in a buffer. Thereby, it is able to effectively utilize the communication bands, and to improve a throughput of the whole system.

### CROSS REFERENCE TO RELATED APPLICATION

This application claims priority from Japanese Priority Document No. 2003-179507, filed on Jun. 24, 2003 with the Japanese Patent Office, which document is hereby incorporated by reference.

### BACKGROUND OF THE INVENTION

1. Field of the Invention

The present invention relates to a wireless communication system, a wireless communication apparatus, a wireless communication method and a computer program for communicating between a plurality of wireless stations such as in a wireless LAN (Local Area Network), and more specifically to a wireless communication system, a wireless communication apparatus, a wireless communication method and a computer program for running a wireless network in which direct communications (random access) are made in an asynchronous mode between terminals. More in detail, the present invention relates to a wireless communication system, a wireless communication apparatus, a wireless communication method and a computer program in which an ad-hoc communication wireless network is established without particularly providing an apparatus acting as a control station, more specifically to a wireless communication system, a wireless communication apparatus, a wireless communication method and a computer program in which each communication station is provided with its own transmission/reception period without causing useless latency.

2. Description of Related Art

By establishing a LAN with a plurality of interconnected computers, it is possible to share information such as files and data, peripheral equipments such as printers and the like, and also to exchange information such as transmission of electronic mails and data contents. Conventionally, it is typical to construct a cabled LAN, which requires laying cables, thereby making it difficult to construct networks with minimum expense. Additionally, after constructing such network, it encountered inconvenience because moving range of equipments was restricted by the cable length.

On the contrary, a wireless LAN is increasingly attracting attention as a system for releasing users from cabling in the cabled LAN. Such wireless LAN enables to eliminate almost all cablings in the working area such as in an office or the like, thereby making it possible to relatively easily move communication terminals such as personal computers (PCs) or the like. As a result of higher operating speed and lower price of a wireless LAN system in recent years, needs for such wireless LANs are significantly increasing. Particularly in recent years, an investigation for introduction of a personal area network (PAN) have been made for performing information communications between a plurality of personal electronic equipments and appliances with a small-scale wireless network.

For example, some different wireless communication systems have been standardized by utilizing such frequency bands as 2.4 GHz and 5 GHz which require no license from an administrative government office. One of the standardized wireless communication networks is the IEEE (The Institute of Electrical and Electronics Engineers) 802.11 or the IEEE 802.15.3. As for the IEEE 802.11 standard, there are various types of wireless communication systems such as the IEEE 802.11a, the IEEE 802.11b, or the like depending on wireless communication systems, frequency bands to be used, etc.

Also, in recent years, a so-called “ultra-wideband (UWB) communication” which carries out the wireless communications by putting information on very weak impulse series is attracting attention as a short range, ultra-high speed wireless communication system, and this system is expected to be made practicable.

As for the UWB transmission system, studies have been made on various physical signal types such as a DS-UWB system in which the spreading speed of a DS (Digital Service) information signal is increased to the extreme, an impulse-UWB system in which information signal is constructed by using very short period impulse signal series in the order of several hundreds picoseconds for transmission and reception of such signal series, etc. Any one of the systems utilizes ultra-wide frequency bandwidth in the range of, for example, 3 GHz to 10 GHz. For example, spread processing is performed within the frequency bandwidth for transmission and reception, thereby realizing high speed data transmission. Its occupied bandwidth is a GHz order in which the occupied bandwidth divided by the center frequency (for example, 1 GHz to 10 GHz) is equal to substantially 1. This is much wider bandwidth as compared to the bandwidth normally used in the wireless LAN such as a so-called W-CDMA, a cdma2000, an SS (Spread Spectrum), or an OFDM (Orthogonal Frequency Division Multiplexing) system.

In the studies for standardizing, for example, the IEEE 802.15.3, standardization is in progress on a method of communicating by forming a piconet between wireless communication apparatus which perform ultra-wideband wireless communication.

In order to construct a local area network using a wireless communication technology, it is typical to provide a single apparatus acting as a control station which is known as “an access point” or “a coordinator” in the area and the network is formed under supervising control of the control station.

In case of transmitting information from a certain communication apparatus in a wireless network having an access point, widely used is an access control method based on a reserved bandwidth in which a bandwidth necessary for transmitting the information is firstly reserved from the access point in order to use the transmission path so that no collision takes place with information transmission by another communication apparatus. In other words, the access point is provided to perform synchronized wireless communication in which all communication apparatus in the wireless network are synchronized with each other.

However, there arises a problem to significantly decrease efficiency of using the transmission path in case of performing asynchronous communication between a transmission side and a reception side in the wireless communication system having the access point because it is absolutely necessary to perform wireless communication through the access point.

On the contrary, as another method of constructing a wireless network, a so-called “ad-hoc communication” for directly performing asynchronous communication between terminals has been proposed. Particularly, in a small-scale wireless network comprising a relatively small number of clients that locate close to each other, it is considered that such ad-hoc communication is suitable because any terminal can directly perform asynchronous wireless communication without using a particular access point.

Now, a conventional wireless networking will be described hereunder in detail by taking the IEEE 802.11 as an example. The networking in the IEEE 802.11 is based on the concept of a BSS (Basic Service Set). The BSS comprises two kinds, in which one is a BSS as defined by an infrastructure mode including a master such as an AP (Access Point or a control station) and the other is an IBSS (Independent BSS) as defined by only an ad-hoc mode including a plurality of MT (Mobile Terminals or movable stations).

Infrastructure Mode:

An operation of the IEEE 802.11 in the infrastructure mode will be described by reference to FIG. 19. An access point to perform coordination is essential in a BSS in the infrastructure mode.

An access point integrates the area where a radio wave reaches in the periphery of its own station as a BSS and constitutes a so-called “cell” in a cellular system. Mobile terminals in the neighborhood of the access point are accommodated in the access point and enter into the network as a member of the BSS. In other words, the access point transmits a control signal, which is known as a beacon, at an appropriate time interval. Any mobile terminal capable of receiving the beacon is considered to be located near the access point, and establishes a connection with the access point.

In the example as shown in FIG. 19, a communication station STA0 operates as the access point and the other communication stations STA1 and STA2 operate as the mobile terminals. Note that the STA0 as the access point transmits the beacon at a constant interval as shown in the chart at the right side in FIG. 19. The transmission time of the next subsequent beacon is informed within the beacon as a parameter of a target beacon transmit time (TBTT). And when it comes to the TBTT, the access point initiates the beacon transmission procedure.

Upon receiving the beacon, neighboring mobile terminals around the access point decode the internal TBTT field for recognizing the next subsequent beacon transmission time, thereby making it possible to shut-off the power of the receiver and to enter the sleeping state until the TBTT for the next subsequent or some later TBTT depending on the case (or in case when reception is unnecessary).

Ad-Hoc Mode:

Now, the operation of the IEEE 802.11 in the ad-hoc mode will be described by reference to FIG. 20 and FIG. 21.

In the IBSS in the ad-hoc mode, mobile terminals automatically define the IBSS after performing negotiation among a plurality of mobile terminals. Upon defining the IBSS, a group of mobile terminals determine the TBTT at a constant interval after such negotiation. Upon recognizing arrival of the TBTT by making reference to the clock within its own station, each mobile terminal transmits the beacon after a random time delay in case when it recognizes that no other mobile terminals transmit the beacon.

The particular example as shown in FIG. 20 shows that two mobile terminals constitute the IBSS. In this case, the beacon is transmitted by either one of the two mobile terminals belonging to the IBSS at every time when the TBTT is reached. Also, there is a case when collision of beacon takes place.

Even in the IBSS, there is an instance when the power supply of the mobile terminals is shut off as necessary, thereby going into a sleeping state. FIG. 21 shows signal transmission and reception procedures in this case.

In case when the sleep mode is applied in the IBSS in the IEEE 802.11, a certain time frame from the TBTT is defined as an ATIM (Announcement Traffic Indication Message) window. In the time frame of the ATIM window, all mobile terminals belonging to the IBSS are operating the signal reception procedures. Any mobile terminal operating in the sleep mode is basically capable of receiving in this time frame.

In case when each mobile terminal has information to be sent to a certain designated mobile terminal, it is possible to transmit ATIM packets to the designated mobile terminal after transmitting the beacon in the ATIM window, thereby informing the reception side that the mobile terminal holds information to the designated mobile terminal. The mobile terminal that received the ATIM packets keeps the receiver operating until the end of reception from the ATIM packets transmitting station.

In the example as shown in FIG. 21, there are three mobile terminals, i.e., a STA1, a STA2 and a STA3 in the IBSS. When the TBTT arrives in FIG. 21, each mobile terminal of the STA1, STA2 and STA3 sets its backoff timer while monitoring the media condition over the random interval. The example in FIG. 21 shows the case when the timer of the STA1 disappears earlier than the others, and transmits the beacon. Since the STA1 transmits the beacon, the other SAT2 and STA3 which receive the beacon are refrained from transmitting the beacon.

Also, in the example in FIG. 21, the STA1 holds the transmission information addressed to the STA2 while the STA2 holds the transmission information addressed to the STA3. At this time, both the STA1 and STA2 set the backoff timer again while monitoring the respective media condition over the random time interval after transmission/reception of the beacon. In the shown example, since the timer of the STA2 disappears earlier, the ATIM message is transmitted first from the STA2 to the STA3. Upon receiving the ATIM message, the STA3 feeds the receiving ACK (acknowledge) packet back to the STA2. Upon completion of transmission of the ACK from the STA3, the STA1 further sets the backoff timer while monitoring the respective media condition over the random time interval. When the timer disappears, the STA1 transmits the ATIM packet to the STA2. The STA2 feeds the ACK packet of receiving the ATIM packet back to the STA1.

Upon performing communication of these ATIM packet and ACK packet in the ATIM window, the STA3 operates the receiver in order to receive information from the STA2 in the subsequent interval while the STA2 operates the receiver in order to receive information from the STA1.

In the above procedures, communication stations which do not receive the ATIM packet in the ATIM window or do not hold information to be transmitted to any other station can shut off the power of the transmitter/receiver until the next subsequent TBTT, thereby reducing power consumption.

Incidentally, information processing equipments such as personal computers (PCs) come into wide use, and offices are in a working environment where a variety of equipments are included, thereby including communication stations spreading all over and constructing a plurality of networks in overlapped with one another. Under such circumstances, there arises a need for an access control so that communications between terminals do not conflict with one another.

In a packet communication or the like in which communication requests are in random and burst manner, it is typical to adopt a common channel system in which a plurality of terminal stations share the same frequency channel. Since communication requests from terminal stations are random in the common channel system, it is most likely that signals from a plurality of terminal stations collide with one another, thereby degrading communication quality. In order to avoid such signal collision, a CSMA/CA (Carrier Sense Multiple Access/Collision Avoidance) system is widely adopted because it comprises a relatively simple mechanism. In the ad-hock communication system as described hereinabove, a direct, asynchronous information transmission system is applied in accordance with the access procedures based on the CSMA/CA in order to detect that the communication from the own station does not collide with the others.

On the other hand, in case of transmitting real-time and continuous data such as moving images and the like which require to transmit data periodically at a constant interval, bandwidth must be guaranteed. In such a case, bandwidth is able to be guaranteed by giving a period of time for each communication station constituting the network to prioritize transmission/reception.

However, if a constant prioritized transmission/reception right is given in spite of absence/presence of transmission data, there is a problem where it is impossible to use the communication band effectively. For example, it is absurd to equally give transmission interval to source apparatuses such as VTR, video/audio server, or the like that handles huge amount of transmission data, and to sink apparatuses such as display, headphone, or the like that is a target, and the reception is a main purpose.

For example, in order to maintain communication quality, it is often the case that non-competitive access is employed by way of a slot assignment. By canceling reservation of the slot assigned to each station (for example, see Patent Document 1), it is possible to solve a problem of operation efficiency within a communication band when granting a prioritized transmission/reception right.

However, in this case, when a status of use of the slot which has been assigned by a base station to a mobile station is monitored and if a usage rate is equal to or less than a certain threshold value, the reservation is canceled, and this requires a certain time to cancel a reservation slot.

Further, since a station like the base station is needed for centrally managing mobile stations, an autonomous distributed type system such as an ad-hoc network is difficult to apply.

Patent Document 1: Japanese Laid Open Patent No. H10-135928

### SUMMARY OF THE INVENTION

The present invention provides a wireless communication system, a wireless communication apparatus and a wireless communication method, and a computer program, which are excellent and allow data transmission to be efficiently performed under an ad-hoc communication environment, in which communication stations do not have relations such as a control station and a station to be controlled each other.

Further, the present invention provides a wireless communication system, a wireless communication apparatus and a wireless communication method, and a computer program, which are excellent and allow data transmission with a guaranteed bandwidth to be efficiently performed under an autonomous distributed type communication environment, in which communication stations do not have relations such as a control station and a station to be controlled each other.

Still further, the present invention provides a wireless communication system, a wireless communication apparatus and a wireless communication method, and a computer program, which are excellent and capable of efficiently assigning a communication bandwidth to each communication station according to an amount of transmission data under an autonomous distributed type communication environment, in which communication stations do not have relations such as a control station and a station to be controlled each other.

In view of the above-mentioned problems, the present invention has been made and its first aspect is a wireless communication system which forms a network among a plurality of wireless communication apparatuses not having relations such as a control station and a station to be controlled among them, and the wireless communication system is characterized in that, after sending out a beacon at predetermined frame intervals, each communication station obtains a priority slot with which the communication station itself performs data transmission preferentially and the priority slot can be assigned to another station.

However, the “system” mean herein a thing of a plurality of devices (or functional modules for realizing a specific function) which are gathered logically, regardless of whether or not the devices or the functional modules are in a single housing.

In the wireless communication system in accordance with the present invention, a coordinator is not particularly disposed. Each communication station informs a beacon data so as to make other neighboring (i.e., within its communications range) communication stations know its own existence and notifies a network configuration. Further, a communication station which is newly entering into a communications range of a certain communication station receives a beacon signal, and detects that it enters in the communications range, to thereby know the network configuration by decoding the data described in the beacon.

The communication station can begin to transmit a beacon at a suitable timing when there is no another communication station in the surrounding areas. Subsequently, the communication station which newly enters into the communication areas sets up its own beacon transmission timing so as to avoid a collision with an existing beacon allocation. At this time, since each communication station obtains a priority use area immediately after the beacon transmission, a beacon allocation is carried out according to an algorithm in which the beacon transmission timing of the newly-entered station is set up in turn at a timing substantially in the middle of beacon intervals set up by an existing communication station.

Each communication station describes its own beacon reception timing in a neighboring beacon information field in the beacon, and prepares an adjacent station list about the beacon arrangement of the communication stations existing in the neighborhood within a frame period according to its own beacon reception timing and the neighboring beacon information field (NBOI: Neighboring Beacon Offset Information) in the reception beacon, to thereby manage the network.

By way of the collision avoidance function for the beacons based on the description in the NBOI field, it is possible to know a beacon location of a hidden terminal (i.e. a neighboring station located two stations apart) and avoid the collision of the beacons.

Now, there is a problem that a communication band cannot be used efficiently if a preferential transmitting right is allowed to each communication station at regular time intervals irrespective of whether or not there is a transmission data. For example, it is irrational to provide transmission segments equally to source apparatuses which handle huge transmission data such as a video tape recorder and a video/audio server, and targets such as a display and headphones, i.e., sink devices mainly used for reception.

Thus, in the wireless communication system in accordance with the present invention, according to the case where the priority slot assigned to itself is not being used, that is, in response to permission from an upper layer of a communications protocol, or in response to the fact that the transmission data is not buffered, each communication station lends out its own priority slot to another station that requires it, thereby it is able to use a communication band efficiently, and to improve a throughput of the whole system.

Further, the communication station may get back the slot lent to another station when its own transmission data is generated. Furthermore, it may borrow a slot from another station. It may release the borrowed slot when there is a return request for the slot from the lending station or when there has been no transmission data since then.

A second aspect of the present invention is a computer program described in a computer readable form to perform wireless communication processes, on a computer system, for operating under a wireless communication environment where a specific control station is not disposed, wherein the computer program is characterized by comprising: a priority slot acquisition step of acquiring a priority slot by which each station itself performs data transmission preferentially at predetermined time intervals under the above-mentioned wireless communication environment; a priority slot lending step of releasing its own priority slot or allocating it to another station; and a priority slot borrowing step of using the priority slot of another station.

The computer program in accordance with the second aspect of the present invention is a computer program defined and described in the computer readable form to realize a predetermined process on the computer system. In other words, a collaborative operation is realized on the computer system by installing the computer program in accordance with the second aspect of the present invention in the computer system so as to operate as a wireless communication apparatus. A plurality of such wireless communication apparatuses are started to constitute a wireless network, so that the same operations and effects as those of the wireless communication system in accordance with the first aspect of the present invention can be provided.

Further objects, features, and advantages of the present invention will be apparent from embodiments of the present invention to be mentioned later and detailed description based on the accompanying drawings.

According to the present invention, it is possible to provide a wireless communication system, a wireless communication apparatus and a wireless communication method, and a computer program, which are excellent and allow data transmission to be efficiently performed under an ad-hoc communication environment where an apparatus to be a control station is not particularly disposed.

Further, according to the present invention, it is possible to provide a wireless communication system, a wireless communication apparatus and a wireless communication method, and a computer program, which are excellent and allow data transmission with a guaranteed bandwidth to be efficiently performed under an autonomous distributed type communication environment, such as an ad-hoc communication.

Further, according to the present invention, it is possible to provide a wireless communication system, a wireless communication apparatus and a wireless communication method, and a computer program, which are excellent and capable of efficiently assigning a communication bandwidth according to an amount of transmission data under an autonomous distributed type communication environment, such as an ad-hoc communication.

In the wireless communication system in accordance with the present invention, by informing the beacon data, each communication station can perform communication operation by way of autonomous distribution and acquire the priority use area immediately after transmitting the beacon. Further, when the slot assigned to its own station is not being used, the slot is lent out to the station needing it, whereby realizing efficient use of the communication band and improvement in the throughput.

### BRIEF DESCRIPTION OF THE DRAWINGS

In the accompanying drawings:

FIG. 1 is a diagrammatic functional construction of the wireless communication apparatus capable of operating as a communication station in the wireless network according to the present invention;

FIG. 2 is a chart to describe beacon transmission procedures of each communication station;

FIG. 3 is an example of the beacon transmission timings;

FIG. 4 is a chart to define packet intervals;

FIG. 5 is a timing chart to show the way how the transmission priority right is granted to the station which transmitted the beacon;

FIG. 6 is a timing chart to show the transmission priority period and the conflicting transmission period within a super frame interval;

FIG. 7 is an example of the packet format;

FIG. 8 is an example of the beacon signal format;

FIG. 9 is an example of a NBOI description;

FIG. 10 is a chart to describe the mechanism of collision of beacon avoidance by using a NBOI;

FIG. 11 is a chart to show the way how the beacon transmission timing of a newly entered communication station STA2 is determined at substantially the center of beacon intervals between STA0 and STA1;

FIG. 12 is a chart to show an operation in which a communication station lends out a priority slot with procedure;

FIG. 13 is an example of the beacon signal format;

FIG. 14 is a diagram to show an example of a structure of a lending request command of the priority slot and a priority slot lending permission command;

FIG. 15 is a chart to show a state where the priority slot is returned periodically;

FIG. 16 is a chart to show an operation in which a communication station lends out the priority slot without procedure;

FIG. 17 is a chart to show an operation of returning the priority slot;

FIG. 18 is a chart to show a procedure of a lending operation of the priority slot by means of a radio communication apparatus;

FIG. 19 is a chart for explaining a radio networking operation of IEEE802.11 at the time of an infrastructure mode;

FIG. 20 is a chart for explaining a radio networking operation of IEEE802.11 at the time of an ad-hoc mode; and

FIG. 21 is a chart for explaining the radio networking operation of IEEE802.11 at the time of the ad-hoc mode.

### DETAILED DISCRIPTION OF THE PREFERRED EMBODIMENT

With reference to the drawings, the embodiments of the present invention will be described in detail.

A transmission path for communications currently assumed in the present invention is wireless, and by using a single transmission media (when a link is not separated by a frequency channel) a network is built among a plurality of communication stations. However, even if it is the case where a plurality of frequency channels exist as the transmission media, the effect of the present invention can be similarly enjoyed. Further, the communications currently assumed by the present invention are store-and-forward type traffic, and information is transmitted per packet.

A wireless network system in accordance with the present invention has a system configuration where a coordinator is not disposed, and each communication station basically performs an ad-hoc communication, for example, which transmits information directly and asynchronously according to an access procedure based on CSMA (Carrier Sense Multiple Access).

In such a wireless communication system where a coordinator is not particularly disposed, each communication station informs a beacon data so as to make other neighboring (i.e., within its communications range) communication stations know its own existence and notifies a network configuration. Further, a communication station which is newly entering into a communications range of a certain communication station receives a beacon signal from another communication station, and detects that it has entered the communications range, to thereby know the network configuration by decoding the data described in the beacon.

Processes in each communication station to be described below are basically processes performed in all communication stations entering into the network. In some cases, however, all the communication stations constituting the network do not perform processes to be described below.

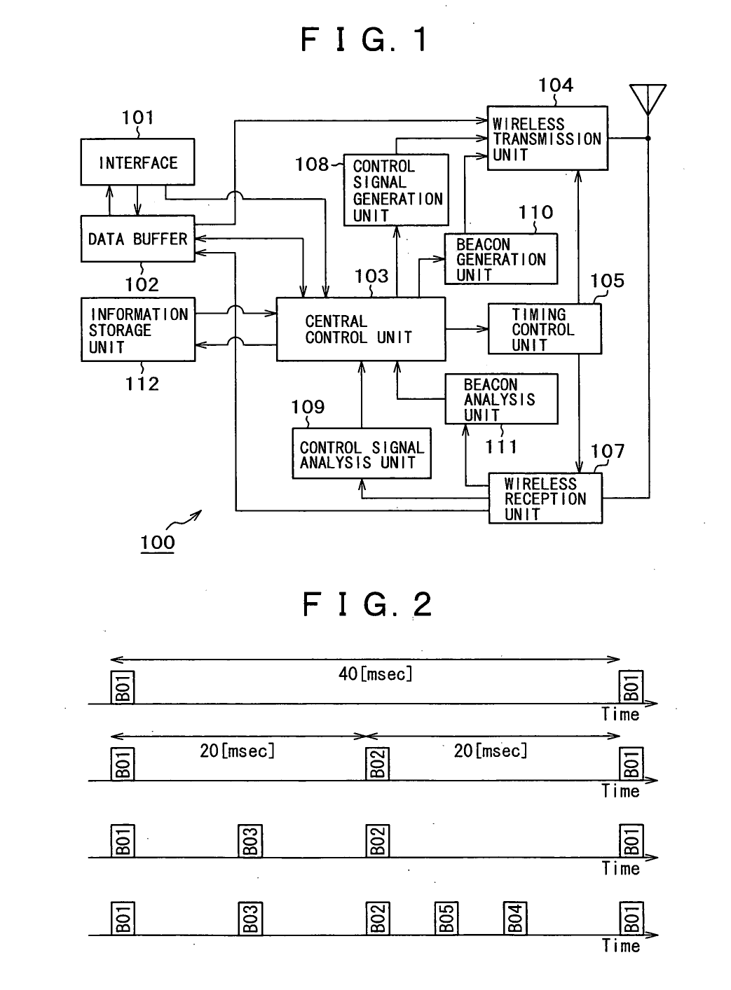

FIG. 1 schematically shows functions and structure of a wireless communication apparatus which can operate as a communication station in a wireless network in accordance with the present invention.

As for the wireless communication apparatus as shown in the figure, the wireless communication apparatus 100 comprises an interface 101, a data buffer 102, a central control unit 103, a wireless transmission unit 104, a timing control unit 105, an antenna 106, a wireless reception unit 107, a beacon generation unit 110, a beacon analysis unit 111, and an information storage unit 112.

The interface 101 exchanges a variety of information data with an external apparatus (for example, a personal computer (not shown) etc.) connected to this wireless communication apparatus 100.

The data buffer 102 is used for temporarily storing a data sent and received from an apparatus connected through the interface 101 before sending it out via the interface 101.

The central control unit 103 consolidates a series of management of information transmission and reception processes in the wireless communication apparatus 100, and access control of the transmission path.

In order to wirelessly transmit the data and the beacon which are temporarily stored in the data buffer 102, the wireless transmission unit 104 modulates them as an ultra-wide band signal, for example.

The timing control unit 105 controls a timing for carrying out processes of transmitting and receiving an ultra-wide band signal. For example, this timing control unit 105 controls an previously acquired priority slot area, its own beacon transmission timing, a beacon reception timing from another communication apparatus, etc.

The antenna 106 wirelessly transmits a signal to the other wireless communication apparatus, and collects signals sent by the other wireless communication apparatuses.

The wireless reception unit 107 carries out a process of receiving the signals such as information and a beacon sent by other wireless communication apparatuses for a predetermined time period.

The beacon generation unit 110 generates beacon signals that are periodically exchanged with the wireless communication apparatuses which are in the neighborhood.

The beacon analysis unit 111 analyzes the received beacon signals of other wireless communication apparatuses and knows the wireless network configuration and its own data transmission/reception timing.

The information storage unit 113 stores instructions for performing procedures such as a series of access control operations performed in the central control unit 103 and a network configuration data acquired by analyzing the beacons.

At the time of data transmission, after a header, a CRC (Cyclic Redundancy Code), etc. are added to transmission data stored in the data buffer 102, an encoding/modulating process is performed in the wireless transmission unit 104. Then a transmission signal is transmitted out of the antenna 106 through an antenna diplexer (not shown), provided with an error correcting code at the time of encoding, and converted to modulated signals such as BPSK, QPSK, QAM, etc. by way of modulation, and further converted and amplified into a desired carrier frequency. On the other hand, the received signal passes through the antenna 106 and the antenna diplexer is subjected to a demodulating/decoding process, and is further subjected to a CRC check. The received data is outputted when there is no error.

Now, operations will be described which are performed by the wireless communication apparatus as the communication station in the wireless network system in accordance with the present invention. In the wireless communication environment where the coordinator does not exist, each communication station periodically transmits beacons with an object to notify its own existence in the surrounding areas (i.e., its own communication areas). Each communication station can acquire a predetermined time interval immediately after transmitting a beacon as a priority use area which the communication station itself can preferentially use for transmission (transmission and/or reception) of information.

A time interval divided by transmission of beacons is referred to as a “super frame interval.” In this embodiment, a transmitting interval of the beacon at the communication station is set to 40 milliseconds, and a beacon shall be transmitted for every 40 milliseconds. However, the super frame interval is not necessarily limited to 40 milliseconds. The super frame interval is divided into slots, and its access is managed per slot. The priority use area provided to each communication station is referred to as a “priority slot.”

A beacon transmitting procedure for each communication station in accordance with this embodiment will be described with reference to FIG. 2.

Assuming that information transmitted by way of a beacon has 100 bytes, an amount of time of the transmission becomes 18 microseconds. Since one transmission is carried out for 40 milliseconds, a media share rate of the beacon for every communication station is 1/2222, which is sufficiently small.

Each communication station STA is gradually synchronized whilst hearing the beacon transmitted in surrounding areas. When a communication station appears newly, the new communication station sets up its beacon transmission timing so as not to collide with the beacon transmission timing of the existing communication station.

When there is no communication station in the surrounding areas, a communication station 01 is able to begin to transmit a beacon at a suitable timing. The beacon transmitting interval is 40 milliseconds (as mentioned above). In the example as shown in the highest rung of FIG. 2, B01 indicates the beacon signal transmitted from the communication station 01.

Hereafter, a communication station that newly enters into the communication areas sets up its own beacon transmission timing so as not to collide with the existing beacon allocation. At this time, since each communication station acquires its own priority slot immediately after the beacon transmission, it is preferable in terms of transmission efficiency that the beacon transmission timings of respective communication stations are equally distributed within the super frame interval rather than crowding. Therefore, in this embodiment, the beacon transmission is started substantially in the middle of the longest time period of a beacon interval within a range where the communication station itself can hear basically.

For example, it is assumed that a new communication station 02 appears in the network condition including only the communication station 01 as shown in the highest rung in FIG. 2. At this time, the communication station 02 recognizes the presence and the beacon position of the communication station 01 by receiving the beacon B01 from the communication station 01, and starts to transmit its beacon B02 by setting the beacon position at substantially the center of the beacon interval of the communication station 01 as shown in the second rung in FIG. 2.

Furthermore, it is assumed that another new communication station 03 appears. At this time, the communication station 03 receives at least one of the beacons B01 and B02 from the communication station 01 and the communication station 02, and recognizes the presence of these existing communication stations. Then, the communication station 03 starts to transmit its beacon B03 at substantially the center position of the interval between the two beacons B01 and B02 from the communication stations 01 and 02 as shown by beacon B03 in the third rung in FIG. 2.

Thereafter, the beacon interval becomes narrower as new neighboring communication stations enter into the network in accordance with the same algorithm. For example, as shown in the bottom rung in FIG. 2, a communication station 04 which appears after the communication station 03 sets its beacon transmission timing at substantially the center timing of the beacons B02 and B01 from the communication stations 02 and 01 as shown by beacon B04, while a further newly appearing communication station 05 sets its beacon transmission timing at substantially the center timing of the beacons B02 and B04 from the communication stations 02 and 04 as shown by beacon B05.

However, it is to be noted that the minimum beacon interval Bmin is set so that beacons do not overflow from the bandwidth (super frame interval). If it is assumed, for example, that the minimum beacon interval Bmin is regulated to 625 μsec, only up to 64 communication stations can be accommodated in the service area of the radio wave.

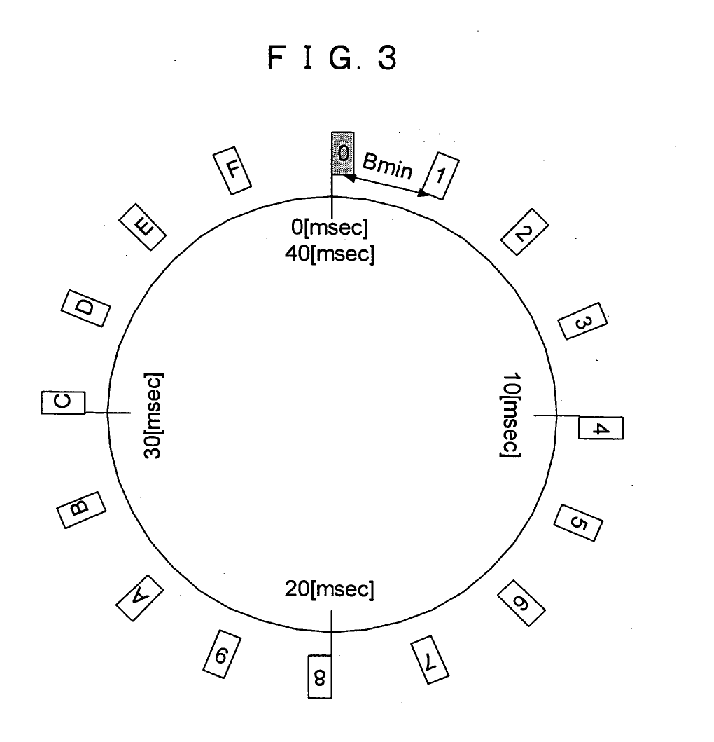

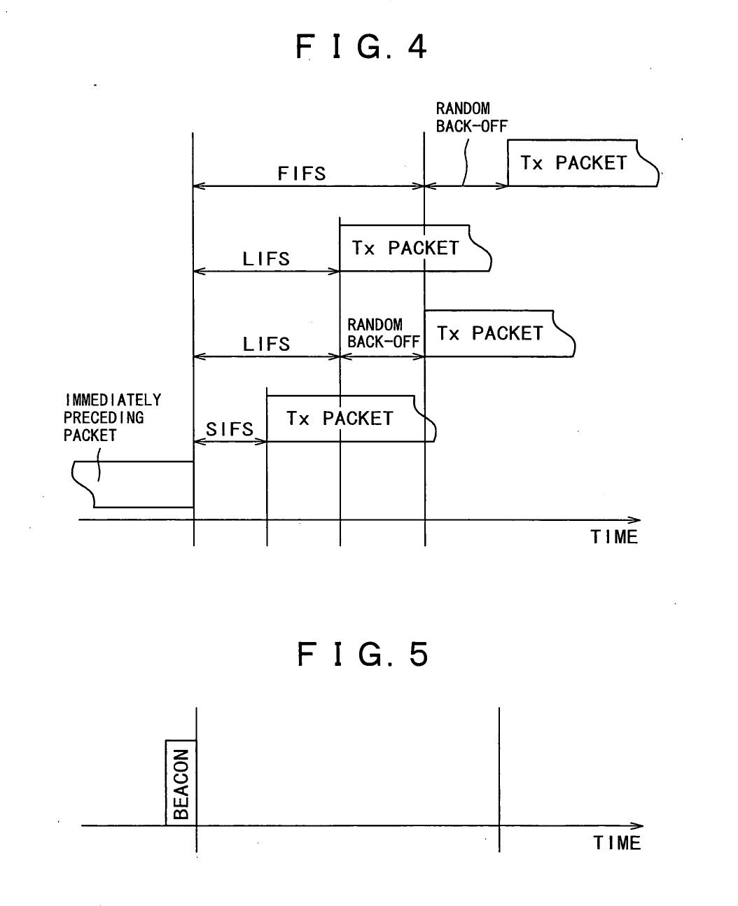

FIG. 3 shows an example of the beacon transmission timing. However, in the example as shown in FIG. 3, time lapse of the 40 msec super frame interval is indicated by a hand of a clock which rotates clockwise on a circle.

In the example as shown in FIG. 3, totally 16 communication stations from 0 to F constitute nodes of the network. It is assumed that the beacon allocation is set in accordance with the algorithm to sequentially set the timing for newly entered communication stations at substantially the center of the beacon intervals set by the existing communication stations as described hereinabove by reference to FIG. 2. In case of regulating the Bmin to 2.5 msec, no more communication stations can enter into the network. Such phase of starting to transmit the beacon from each communication station at the positions in accordance with the above procedures is referred to as “step 1” below. Detailed procedures of determining the beacon transmission positions will be described hereinafter.

In the wireless network according to the embodiment of the present invention, it basically adopts the access procedures based on the CSMA similar to the conventional procedures, i.e., transmission is carried out after confirming that the medium is clear prior to transmission. However, after transmitting the beacon signal to let the other neighboring communication stations know its presence, each communication station acquires a priority slot in which the communication station can transmit information in priority over others. Each communication station is able to release its own priority slot, or to lend the priority slot to the other communication stations when there is no transmission data, but detail procedure is described later.

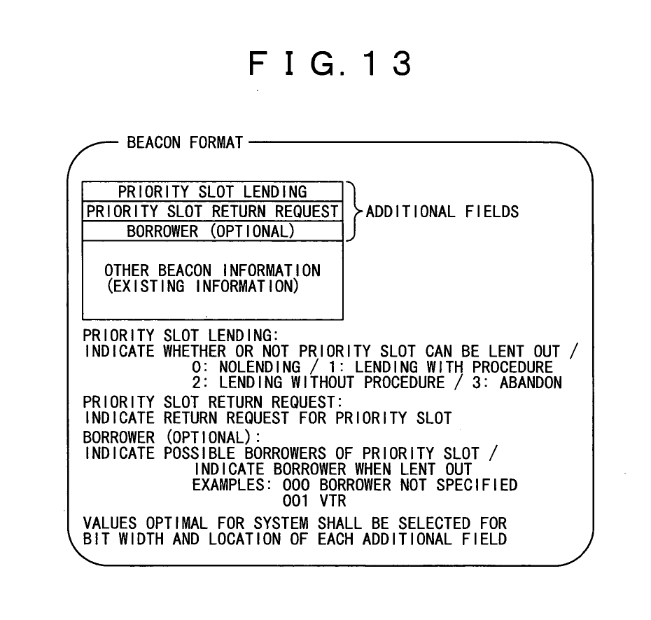

Similar to the case of the IEEE 802.11 system or the like, a plurality of packet intervals can be defined as well in this particular embodiment. Now, definition of the packet interval in this embodiment will be described with reference to FIG. 13. The packet interval defines a SIFS (Short Inter Frame Space) and a LIFS (Long Inter Frame Space). The SIFS packet interval is granted only to the prioritized packets and other packets are permitted to be transmitted in LIFS plus the random backoff packet interval which is acquired in random after confirming that the medium is clear. Any known method can be applied to a calculation method of the random backoff value.

Moreover, in the particular embodiment, “LIFS” and “FIFS (Far Inter Frame Space)+backoff” are defined other than the above described “SIFS and LIFS+backoff”. Although the “SIFS” and “LIFS+backoff” packet intervals are normally adopted, in time frames when the prioritized transmission right is granted to a certain communication station, other communication stations use the “FIFS+backoff” packet intervals and the communication station to which the priority right is granted uses the SIFS or LIFS packet intervals.

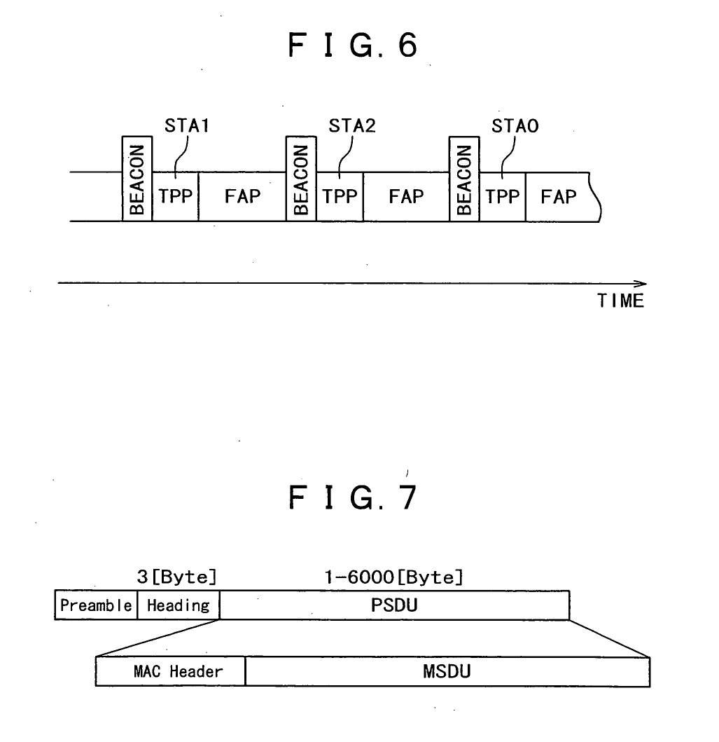

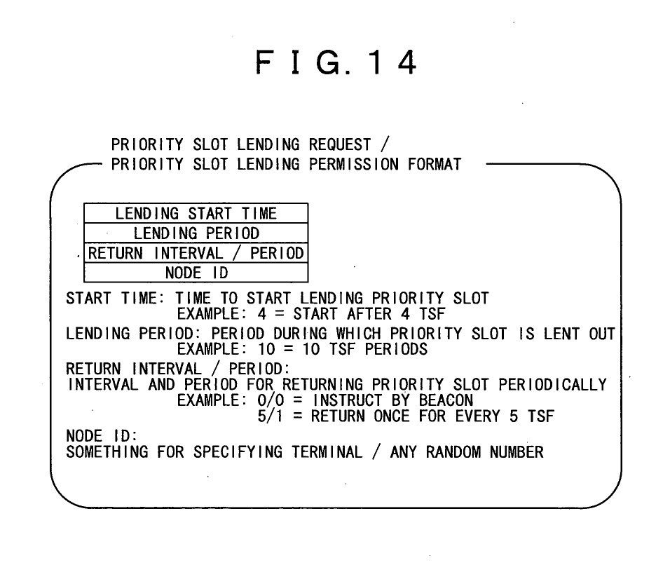

Although each communication station transmits the beacon at a constant interval, the priority right is granted to the communication station which transmitted the beacon for a certain time after transmitting the beacon. FIG. 14 shows how the priority right is granted to the beacon transmitting station. The prioritized period is defined as a TPP (Transmission Prioritised Period) while the remaining periods other than the TPP are defined as a FAP (Fairly Access Period). FIG. 6 shows a structure of the super frame interval. As shown in FIG. 6, subsequent to transmission of the beacon from each communication station, the TPP for the particular communication station which transmitted the beacon is allocated and after the lapse of time equal to the TPP, the FAP follows until it terminates at the transmission of the beacon by the next subsequent communication station. Although the TPP started immediately after transmission of the beacon in this particular example, the invention should not be limited only to such example and the commencing time of the TPP may be set to, for example, any relative position (time) with respect to the beacon transmission time.

Now, the packet interval will be discussed again hereunder. Each communication station transmits in the FAP at the interval of the LIFS+backoff. On the other hand, as to the transmission of the beacon and the packets within its own TPP, it is permitted to transmit at the SIFS interval. As to the packet transmission within its own TPP, transmission at the LIFS interval is also permitted. On the other hand, as to packet transmission within the TPP granted to other communication stations, it is transmitted at the FIFS+backoff interval. Although the packet interval is always equal to the FIFS+backoff in the IEEE 802.11 system, the interval can be more shortened in the present arrangement, thereby achieving more efficient packets transmission.

Although it is described in the above example that the prioritized transmission right is granted only to the communication station in the TPP, such prioritized transmission right can also be granted to the communication station accessed by the communication station in the TPP. Although transmission is basically prioritized in the TPP, in case where there is nothing to send in the own (or calling) communication station but it is known that the other communication station holds information to be transmitted to the calling communication station, it is possible to send a paging message or a polling message to “the other” communication station.

On the contrary, in case when the beacon is transmitted but the communication station has nothing to send and when it is unknown if the other communication station holds any information to be transmitted to the calling communication station, it is possible that the communication station do nothing, and abandon its prioritized transmission right granted in the TPP, thereby transmitting nothing. As a result, any other communication station can start transmission even in the time frame after lapse of the LIFS+backoff or the FIFS+backoff.

In consideration of the structure in which the TPP follows immediately after the beacon as shown in FIG. 6, it is preferable in terms of transmission efficiency that beacon transmission timings of the communication stations are equally spread within the super frame interval rather than densely concentrated. Accordingly, in the particular embodiment, the beacon transmission is basically started at substantially the center of the longest time zone of the beacons in the area where the communication station can listen its own beacon.

FIG. 7 shows an exemplified packet format in the wireless network system according to one embodiment of the present invention. Added at the head of a packet is a preamble which comprises a unique word for the purpose to let the other communication stations know the presence of each communication station.

Transmitted immediately after the preamble is a heading section where attribute, length, and transmission power of the packet are stored and also stored is the transmission rate of the payload portion if the PHY is in the multi-transmission rate mode. The transmission rate of the heading portion is decreased so that the required SNR can be lower than the payload portion by about several dB. The heading portion differs from the so-called MAC header. In the shown example, the MAC header is included in the payload portion.

The payload portion is a portion as indicated PSDU (PHY Service Data Unit) for storing bearer bit series which include control signals and information. The PSDU comprises the MAC header and the MSDU (MAC Service Data Unit) and it is the MSDU portion where data series transferred from the higher layer are stored.

In the following descriptions, in order to describe specifically, it is assumed that the length of the preamble is 8 μsec, the bit rate of transmission of the payload portion is 100 Mbps, the heading section is 3 Bytes, and transmitted at 12 Mbps. In other words, in order to transmit or receive one PSDU, there causes an overhead of 10 μsec (8 μsec preamble+2 μsec heading).

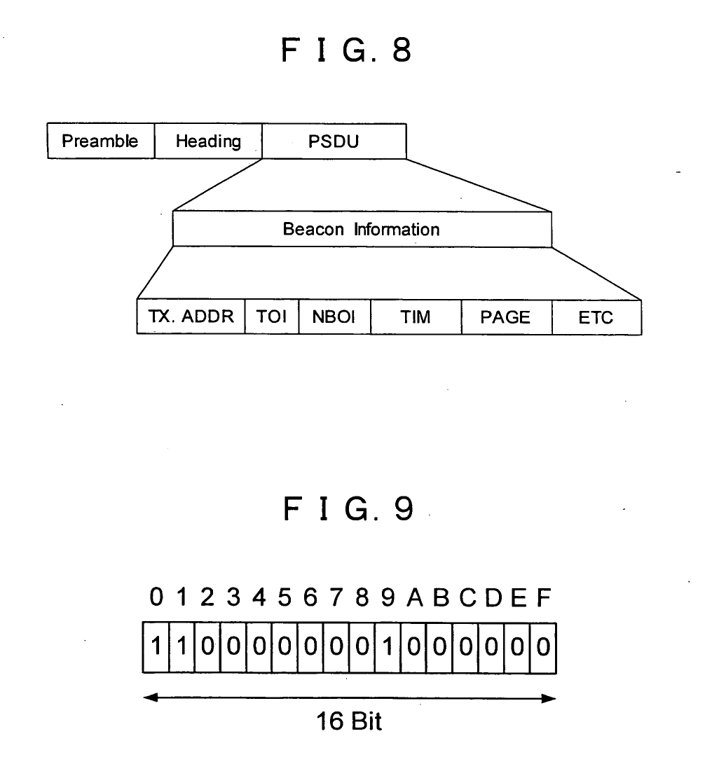

FIG. 8 shows an example of the beacon signal format. As shown in FIG. 8, the beacon signal comprises a preamble to let the other communication stations know the presence of a particular communication station followed by a heading and a payload portion PSDU. It is the heading portion to carry information that the packet is the beacon. Also contained in the PSDU is the following information to be informed to the other communication stations.
Tx. ADDR: MAC address of the transmitter (Tx)
TOI: TBTT Offset Indicator
NBOI: Neighbor Beacon Offset Information
TIM: Traffic Indication Map
PAGE: Paging

The TIM is information to notify that the communication station currently holds information to be transmitted to particular communication stations. Reference is made to the TIM in order to recognize that the receiving station must receive. The Paging is a field to indicate that one of the receiving stations listed in the TIM is scheduled to transmit at the next subsequent TPP. The communication station which is designated in the field must prepare for reception in the TPP. Another field (i.e., ETC field) is also prepared.

The NBOI is information which describes beacon allocations of neighbor communication stations. Since there are up to 16 beacon positions within the super frame interval in this particular embodiment, the NBOI is constructed as a 16 bits long field corresponding to each beacon position and describes the information regarding the received beacon positions in a bit map format. And, by setting the beacon transmission timing of the own station as a reference, 1 is written as a bit at a relative position corresponding to the beacon receiving timing from each communication station while remaining 0 at the bit position corresponding to the relative positions where no beacons are transmitted.

FIG. 9 shows an example of describing the NBOI. In the example as shown in FIG. 9, the NBOI field indicates that the communication station 0 as shown in FIG. 3 is “capable of receiving beacons from the communication station 1 and the communication station 9”. Regarding the bits corresponding to the relative positions of the beacons which are capable of receiving, a mark is allocated if the beacon is received while allocating a space if not received. It is to be noted, for other purposes, those marks may be used at the bit locations corresponding to the timing when no beacons are received. In this particular embodiment, communication stations receive beacons from one another in order to avoid collision of beacon based on the description of the NBOI in each beacon.

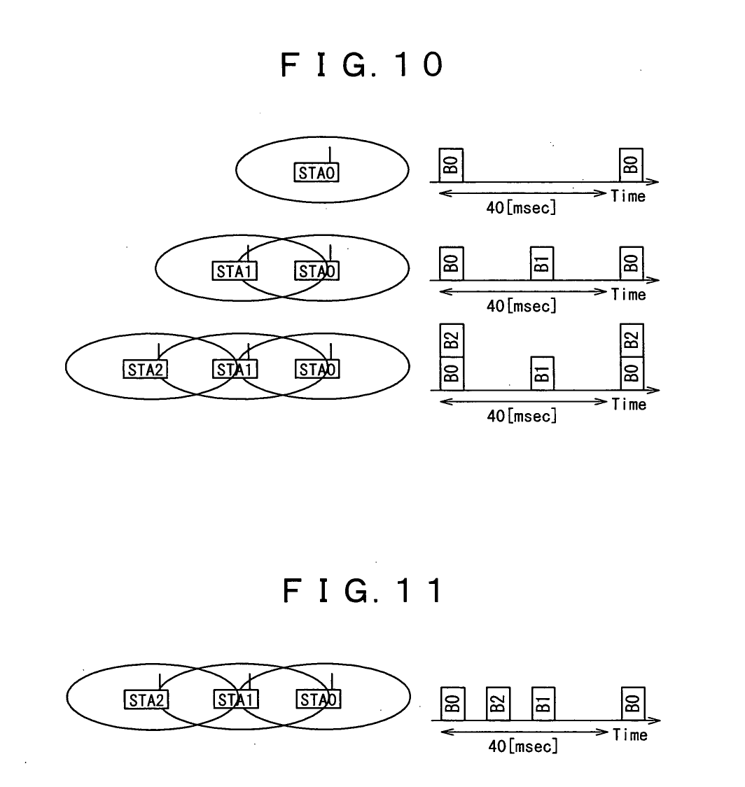

FIG. 10 shows how each communication station avoids collision of beacon based on the description of the NBOI. The way how the communication stations STA0 to STA2 enter is shown in each rung in FIG. 10, wherein the location of each communication station is shown at the left side in each rung while showing the position of the beacon transmitted from each communication station at the right side.

Shown in the higher rung in FIG. 10 is the condition when only station STA0 exists. At this time, the communication station STA0 tries to receive beacons but no beacons can be received. As a result, the communication station STA0 arbitrarily sets the beacon transmission timing and transmits the beacon whenever the beacon transmission timing arrives. The beacon is transmitted at every 40 msec. All bits in the NBOI field carried in the beacon from the communication station STA0 are 0 at this time.

Shown in the middle rung in FIG. 10 is a state when another communication station STA1 enters into the communication area of the communication station STA0. The STA1 tries to receive the beacons, and successfully receives the beacon from the STA0. Since all bits in the NBOI field of the beacon from the STA0 are 0 except the bit at its own transmission timing, the STA1 sets its beacon transmission timing at the substantially center of the beacon interval from the STA0 in accordance with the step 1 which is described hereinabove.

The NBOI field of the beacon which is transmitted from the STA1 is set to 1 in the bits corresponding to the beacon transmission timing from its own station and the beacon receiving timing from the STA0 while filling 0 in all other bits. Also, upon recognizing the beacon from the STA1, the STA0 sets the corresponding bit position in the NBOI field to 1.

Shown in the lowest rung in FIG. 10 is a state when the STA2 subsequently enters into the communication area of the communication station STA1. In the shown example, the STA0 is a hidden terminal relative to the STA2. Accordingly, since the STA2 is unable to recognize that STA1 is receiving the beacon from the STA0, it is possible that the STA2 transmits the beacon at the same timing as the STA0, thereby causing collision as shown at the right side.

The NBOI field is used in order to avoid this phenomenon. Firstly, the NBOI field in the beacon from the STA1 sets 1 not only at the bit representing its own transmission timing but also at the bit representing the beacon transmission from the STA0. As a result, although the STA2 is unable to directly receive the beacon which the STA0 is transmitting, it recognizes the timing of the beacon which the STA0 is transmitting based on the beacon received from the STA1, thereby avoiding transmission of the beacon at this particular timing. Accordingly, the STA2 sets the beacon transmission timing at substantially the center of the beacon intervals from the STA0 and the STA1 as shown in FIG. 11. Of course, 1 is set to the bit of the NBOI in the beacon which is transmitted from the STA2 at the beacon transmission timing of the STA2 and the STA1.

According to the beacon collision avoidance function based on the description in the NBOI field as described hereinabove, it is possible to recognize the beacon position of the hidden terminal, i.e., a next station beyond the neighbor station, thereby enabling to avoid collision of beacon.

As described hereinabove, in the wireless communication system according to this particular embodiment, each communication station transmits the beacon information to let the other communication stations know the presence of its own station as well as the network configuration. Also, any new communication station to enter into the network detects entering into the communication area by receiving beacon signals, and interpreting the information included in the beacons, thereby constructing a new network by transmitting its beacon in such a manner to avoid collision with the existing beacon signals.

Further, in this embodiment, each communication station is able to acquire the predetermined time interval immediately after transmitting the beacon as the priority slot in which the communication station is able to preferentially use for transmission (transmission and/or reception) of information.

Now, there is a problem that a communication band cannot be used efficiently, if the priority slot is equally provided to each communication station at regular time intervals irrespective of whether or not there is a transmission data. For example, it is absurd to equally give transmission interval to source apparatuses such as VTR, video/audio server, or the like that handles huge amount of transmission data, and to sink apparatuses such as display, headphone, or the like that is a target, and the reception is a main purpose.

For these sink apparatuses, an utility value of the priority slot is low. Thus, in the present invention, when the slot assigned to the station itself is not being used, the slot is lent to another station that requires it, thereby being able to use the communication band efficiently, and to improve the throughput of the whole system. Like sink apparatuses, a communication station which does not have many transmission data may assign its own priority slot to another station with or without procedure.

Priority Slot Lending with Procedure:

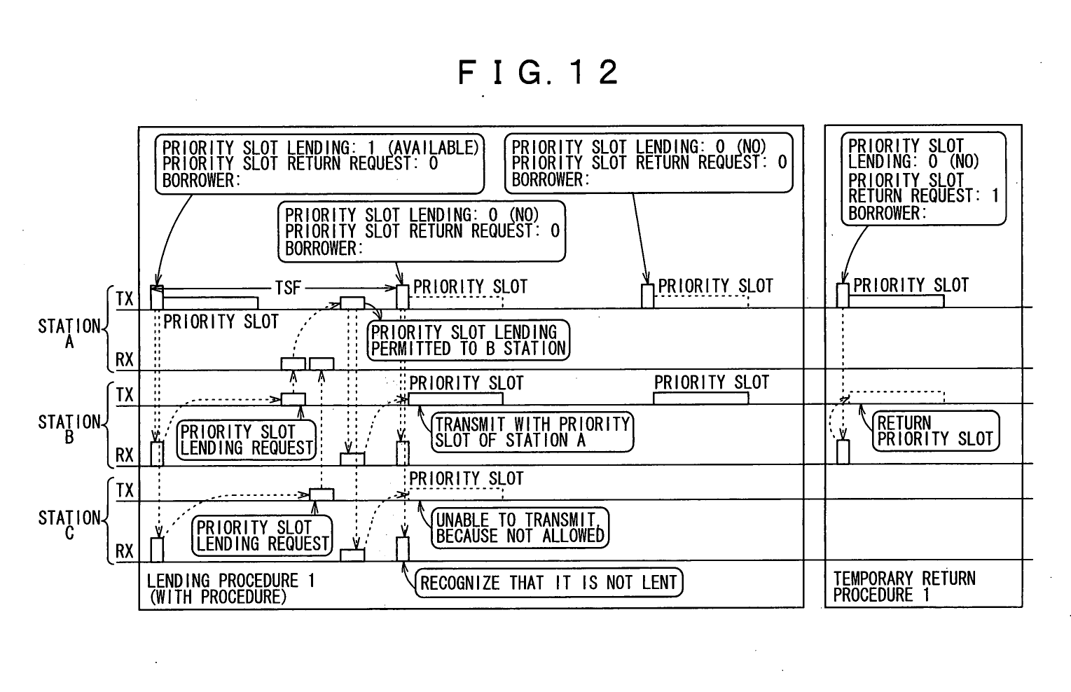

Now, an embodiment in which a priority slot is lent with procedure will be described with reference to FIG. 12.

In the example as shown in this figure, a station A to become the lender of the priority slot informs whether or not its own priority slot can be lent by means of its own transmission beacon. An apparatus of the borrower may be described as a data described in the beacon. For example, if the station A is an output target of AV data, such as a display, it is often the case that it is connected with a television tuner, a video recording and reproducing apparatus, etc., so that it may be possible to describe information on lending the priority slot preferentially to the apparatuses which are in the relation of source and sink.

FIG. 13 shows an example of a structure of the beacon signal used in this embodiment. As shown in the figure, to the existing beacon data (see FIG. 8), additional fields are provided which respectively describes the presence/absence of lending of the priority slot, the return request for the priority slot, and the possible borrower of the priority slot.

If a code “1” is written in a priority slot lending field, it is shown that the priority slot is permitted to be lent. Further, if a code “0” is written in a return request for the priority slot field, it is shown that the return of the priority slot is still unnecessary.

Assuming that a beacon signal in which it is described that the priority slot is permitted to be lent is received from the station A by neighboring stations B and C. If both the stations B and C handle a large amount of transmission data and want to use not only their own priority slots but other stations', they issue a lending request command for a priority slot to the station A.

When receiving the lending request command for the priority slot, the station A determines a borrower of the priority slot according to the priorities of possible borrowers (relationship between the source and the sink, etc.) or the order of arrival of request commands, and returns a priority slot lending permission command to each of stations that issue the request command.

FIG. 14 shows an example of a structure of the lending request command for the priority slot and the priority slot lending permission command. In the example as shown in the figure, each command is provided with fields in which a lending start time, a lending period, a return interval or return period, and a node ID are written.

The lending start time is written in such a format that a time to start lending the priority slot is after certain super frame intervals, for example. Further, the lending period is described, for example, in such a way that a period where the priority slot is lent out has certain super frame intervals.

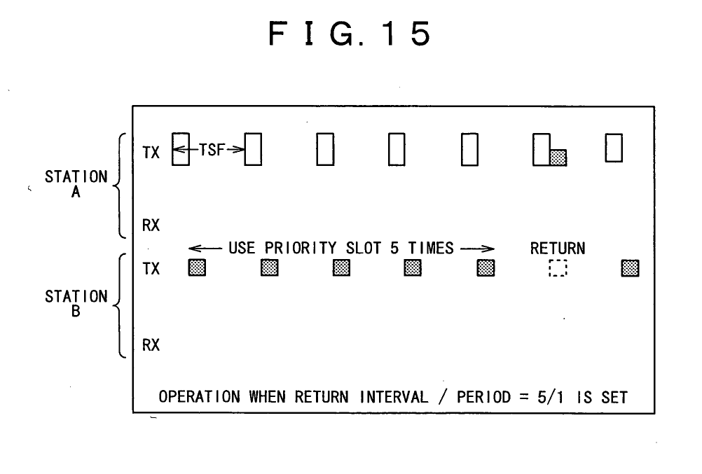

As to the return interval or return period, an interval and a period in which the priority slot is periodically returned are described. For example, “5/1” indicates that the priority slot is returned once for every five super frame intervals (see FIG. 15).

Further, “0/0” indicates that the return interval or return period will be specified by the beacon from time to time.

The node ID may only be information which can specify a terminal, is not particularly limited, and may be a random number, for example.

In the example as shown in FIG. 13, the station A permits the station B to borrow the priority slot. As a result, the station B which is a requester to borrow the priority slot is able to perform transmission by means of the priority slot of the station A in addition to its own priority slot (not shown). Further, since the station C which is another requester to borrow the priority slot is not permitted by the station A, it is not able to perform transmission by means of the priority slot of the station A.

If completing the priority slot lending process, subsequently the station A writes a code “0” in the priority slot lending field in the beacon signal of its own station so as to show that the lending of the priority slot is not permitted any longer. Further it continues to write a code “0” in a priority slot return request field while it is not necessary to return the priority slot to the station B. Since a code “0” is written in the priority slot return request field of the beacon signal from the station A, the station B continues to use the priority slot of the station A.

Return Process of Priority Slot:

On the other hand, considering that the station itself may want to use the priority slot while the priority slot is lent to another station, it is necessary to have a mechanism that is able to request a station using the priority slot to return the priority slot.

In the example as shown in FIG. 12, if the station A itself needs to use the priority slot, the station A writes a code “0” in the priority slot lending field in the beacon signal of its own station, shows that the lending of the priority slot is not permitted any longer, and writes a code “1” in the priority slot return request field so as to prompt return of the priority slot. On the other hand, the station B which is the borrower of the priority slot recognizes that it is requested to return the priority slot, and stops using the priority slot of the station A. Then, the station A gets back its own priority slot and uses it to perform data transmission.

Subsequently, the station A writes a code “0” in the priority slot lending field while it is necessary to use its own priority slot, and notifies neighboring stations that it is not possible to lend the priority slot.

Lending Priority Slot without Procedure:

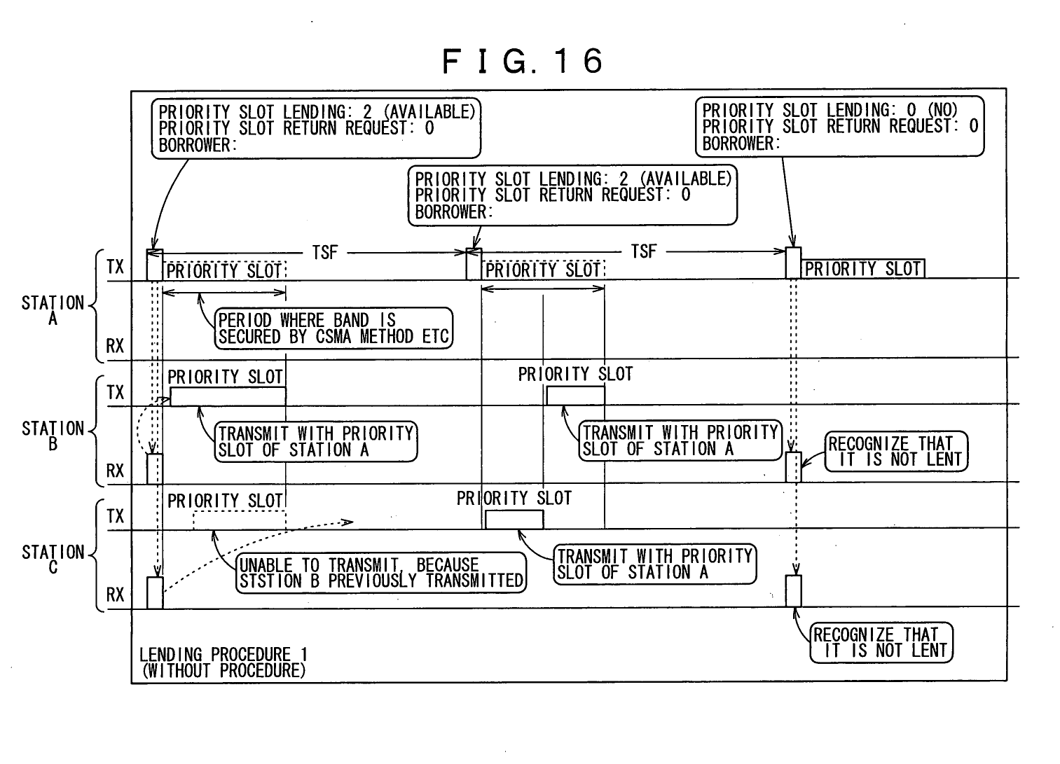

Now, an embodiment in which the priority slot is lent out without procedure will be described with reference to FIG. 16. In this case, it is similar to a method of abandoning the use of the priority slot rather than the lending out the priority slot. Compared with the lending of the priority slot by way of the procedure as shown in FIG. 12, there is an advantage that a process of performing negotiation between the communication stations may be omitted.

In the example as shown in the figure, the station A to be the lender of the priority slot notifies that the station A abandons the priority slot of its own station by means of its own transmission beacon. If a frame structure of the beacon as shown in FIG. 13 is employed, a code “2” indicating the abandonment of the priority slot is written in the priority slot lending field.

Assuming that the beacon signal in which it is described that the priority slot is abandoned is received from the station A by the neighboring stations B and C. If both the stations B and C handle a large amount of transmission data and want to use not only their own priority slots but other stations' priority slot, the priority slot abandoned by a random access system such as for example CSMA/CA etc., is acquired between these communication stations.

In the example as shown in the figure, the station B which starts the data transmission in advance within the priority slot of the station A obtains the priority slot. In this case, it is not necessary to negotiate, such as an exchange of the lending request command of the priority slot for the corresponding lending permission command, with the station A which is the original owner of the priority slot.

The station A writes a code “2” in the priority slot lending field in the beacon signal of its own station, writes a code “0” in the priority slot return request field, and continues to notify the abandonment, while continuing to abandon its own priority slot. The abandoned priority slot is used in a random access procedure such as CSMA/CA among the neighboring communication stations which receive the beacon signal.

The communication station using the priority slot abandoned by another station releases the priority slot when the data transmission is completed within the priority slot. Therefore, one priority slot can be shared by two or more communication stations by way of time-sharing manner. In the example as shown in FIG. 16 a priority slot abandoned by the station A is used by the station C, and then by the station B in the second super frame interval.

Subsequently, when the station A itself requires to use the priority slot, the station A writes a code “0” in the priority slot lending field in the beacon signal of its own station, and notifies that it does not abandon the priority slot any longer. The neighboring communication stations which receive the beacon signal recognize that the lending (abandonment) of the priority slot is not performed, and avoid using the priority slot of the station A.

Return of Priority Slot:

When the lending period set up at the time of lending negotiation expires, the communication station which borrows the priority slot of another station returns the priority slot. When there is no transmission data before the lending period expires, it voluntarily completes the use of the priority slot, and releases the priority slot in order to effectively use the band.

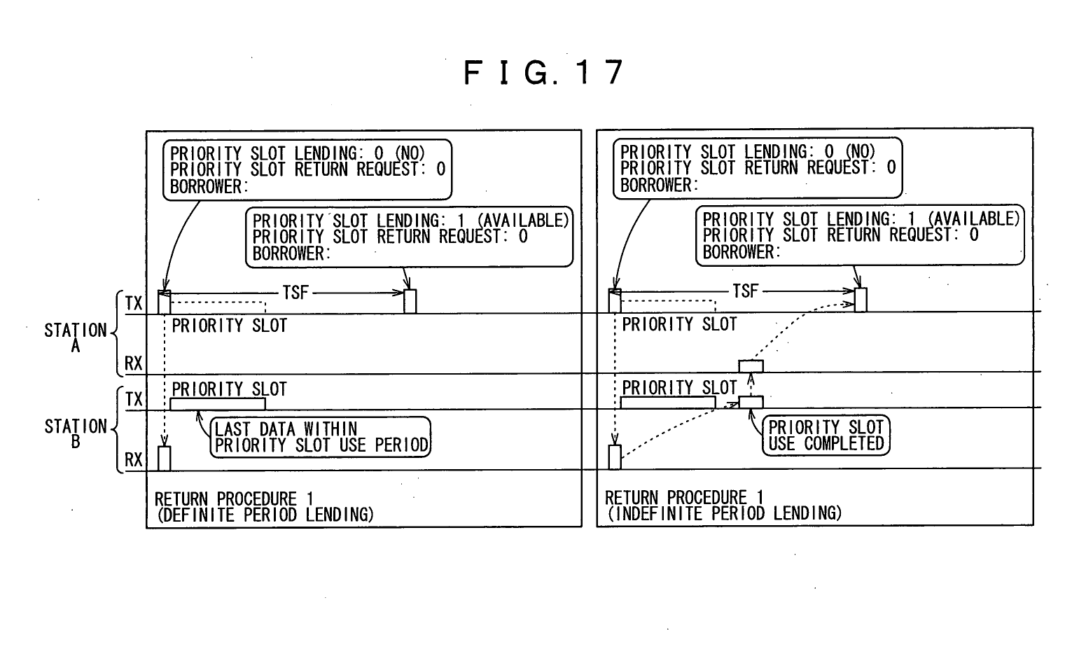

FIG. 17 shows an operation in which the station B using the priority slot lent out from the station A returns the priority slot.

On the left side of the figure, in response to the expiration of the lending period set up at the time of the lending negotiation, the station B returns the priority slot. At this stage, if the station A is still able to lend out the priority slot, the station A writes a code “1” in the priority slot lending field of its own beacon signal so as to show that the lending of the priority slot is permitted.

Further, on the right side of the figure, in response to the completion of the data transmission, the station B returns the priority slot. In this case, the station B transmits a priority slot use completion command to the station A, for example, so as to explicitly show that the priority slot will be returned. At this stage, if the station A is still able to lend out the priority slot, the station A writes a code “1” in the priority slot lending field of its own beacon signal so as to show that the lending of the priority slot is permitted.

Priority Slot Lending Procedure of Wireless Communication Apparatus:

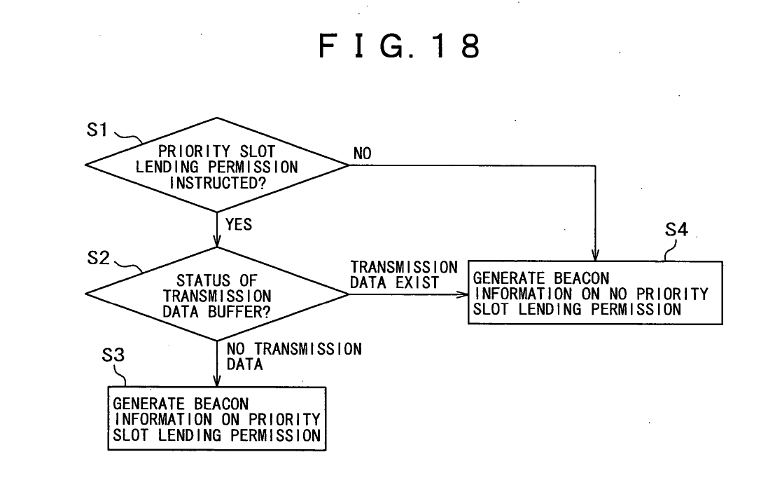

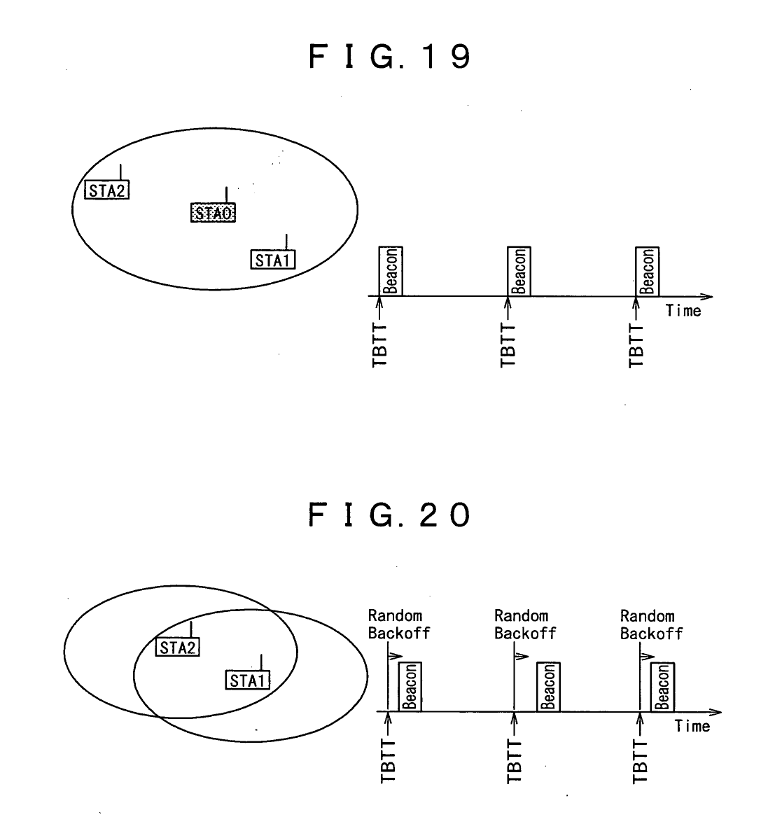

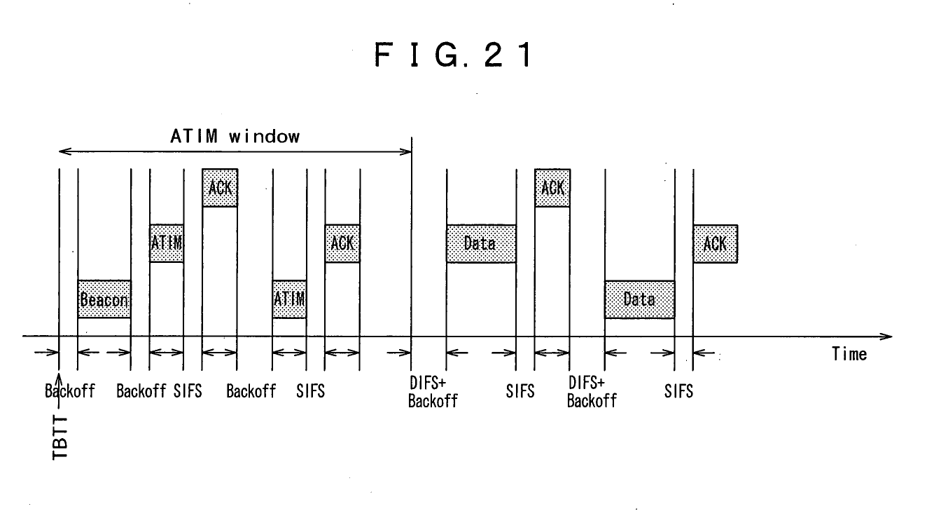

FIG. 18 shows a procedure of a lending operation of the priority slot by means of the wireless communication apparatus.

When an instruction of the lending permission of the priority slot is carried out by the upper layer of the communications protocol (Step S1), it is further determined whether or not the transmission data is stored in the data buffer 102 (Step S2).

At this stage, if there is no transmission data, the beacon data indicating permission of lending the priority slot is generated, and sent out at a predetermined beacon transmission timing (Step S3).

On the other hand, if the lending of the priority slot is not permitted by the upper layer of the communications protocol (Step S1), or if a transmission data not transmitted yet remains in the data buffer 102 (Step S2), the beacon data indicating that the lending of the priority slot is not permitted is generated, and this beacon data is sent out at the predetermined beacon transmission timing (Step S4).

With reference to specific embodiments, the present invention is described hereinbefore, however, it is obvious that a person skilled in the art can modify and substitute the embodiments without departing from the scope of the present invention. In other words, the present invention is disclosed by way of examples, and the description of the specification should not be construed as limiting. In order to determine the feature of the present invention, the claims as recited should be considered.

1. A wireless communication system that is formed with a network among a plurality of wireless communication stations having no relations such as a control station and a station to be controlled each other, wherein:
each communication station is able to acquire a priority slot with which the communication station itself performs data transmission preferentially at a predetermined time interval; and
each communication station is able to release the priority slot, or to allocate the priority slot to another communication station.

2. The wireless communication system as cited in claim 1, wherein;
each communication station acquires the priority slot with which the communication station itself performs data transmission preferentially after sending out a beacon at predetermined frame intervals.

3. The wireless communication system as cited in claim 1, wherein;
each communication station releases or allocates its own priority slot in response to a permission by upper layer of the communication protocol.

4. The wireless communication system as cited in claim 1, wherein;
each communication station releases or allocates its own priority slot based on a fact that the transmission data is not in a buffer.

5. The wireless communication system as cited in claim 1, wherein;
the communication station that allocates its own priority slot to other communication station is able to get back the priority slot from the other communication station.

6. The wireless communication system as cited in claim 1, wherein;
the communication station to which the priority slot is allocated by other communication station releases the priority slot in response to a return request from the other communication station.

7. The wireless communication system as cited in claim 1, wherein;
the communication station to which the priority data is allocated by the other communication station releases the priority slot in response to a fact that the transmission data is not in a buffer.

8. A wireless communication apparatus operating under a wireless communication environment, in which communication stations do not have relations such as a control station and a station to be controlled, wherein:
communication means for transmitting and/or receiving wireless communication data;
control means for controlling operations for transmitting and/or receiving the wireless communication data by said communication means;
priority slot acquisition means for acquiring the priority slot which the communication station itself performs data transmission preferentially under the wireless communication environment at a predetermined time interval;
priority slot lending means for releasing or allocating its own priority slot to other communication station; and
priority slot borrowing means for borrowing the priority slot of other communication station.

9. The wireless communication apparatus as cited in claim 8, wherein;
said priority slot acquisition means acquires the priority slot with which the communication station itself performs data transmission preferentially after sending out a beacon at predetermined frame intervals.

10. The wireless communication apparatus as cited in claim 8, wherein;
said priority slot lending means releases its own priority slot in response to a permission by upper layer of the communication protocol or based on a fact that the transmission data is not in a buffer, or allocates its own priority slot in response to a request from other communication station.

11. The wireless communication apparatus as cited in claim 8, wherein;
said priority slot lending means releases or allocates to the other communication station its own priority slot based on a fact that the transmission data is not in a buffer.

12. The wireless communication apparatus as cited in claim 8, further comprising:
priority slot return request means for requesting getting back of its own priority slot that is released or allocated to other communication station by said priority slot lending means.

13. The wireless communication apparatus as cited in claim 12, wherein;
said priority slot return request means requests the return of the priority slot to the other communication station to which its own priority slot is allocated, in response to a fact that its own priority slot becomes necessary.

14. The wireless communication apparatus as cited in claim 12, wherein;
said priority slot return request means sets an expiration date for the use of the priority slot by the other communication station when allocating its own priority slot to other communication station.

15. The wireless communication apparatus as cited in claim 8, wherein;
said priority slot borrowing means uses the priority slot of the other communication station in response to the release or the allocation of its own priority slot by the other communication station.

16. The wireless communication apparatus as cited in claim 8, further comprising:
said priority slot returning means for releasing or returning the using priority slot borrowed by said priority slot borrowing means to the other communication station.

17. The wireless communication apparatus as cited in claim 16, wherein;
said priority slot returning means releases the using priority slot of other communication station in response to a fact that the its own data transmission is completed.

18. The wireless communication apparatus as cited in claim 16, wherein;
said priority slot returning means returns the priority slot to other communication station in response to a fact that it becomes the end of the expiration date for the use of the priority slot which is set when the priority slot of other communication station is allocated to its own, or in response to a request of the return of the priority slot from the other station.

19. The wireless communication apparatus as cited in claim 16, wherein;
said priority slot returning means returns the priority slot to other communication station in response to a fact that the communication station receives the return request for the priority slot from the other communication station.

20. A wireless communication method operating under a wireless communication environment, in which communication stations do not have relations such as a control station and a station to be controlled, comprising the steps of:
priority slot acquisition step for acquiring the priority slot which the communication station itself performs data transmission preferentially under the wireless communication environment at a predetermined time interval;
priority slot lending step for releasing or allocating its own priority slot to other communication station; and
priority slot borrowing means for borrowing the priority slot of other communication station.

21. The wireless communication method as cited in claim 20, wherein;
said priority slot acquisition step acquires the priority slot with which the communication station itself performs data transmission preferentially after sending out a beacon at predetermined frame intervals.

22. The wireless communication method as cited in claim 20, wherein;
said priority slot lending step releases its own priority slot in response to a permission by upper layer of the communication protocol or based on a fact that the transmission data is not in a buffer, or allocates its own priority slot in response to a request from other communication station.

23. The wireless communication method as cited in claim 20, wherein;
said priority slot lending step releases or allocates to the other communication station its own priority slot based on a fact that the transmission data is not in a buffer.

24. The wireless communication method as cited in claim 8, further comprising:
priority slot return request step for requesting the getting back of its own priority slot that is released or allocated to other communication station by said priority slot lending step.

25. The wireless communication method as cited in claim 24, wherein;
said priority slot return request step requests the return of the priority slot to the other communication station to which its own priority slot is allocated, in response to a fact that its own priority slot becomes necessary.

26. The wireless communication method as cited in claim 24, wherein;
said priority slot return request step sets an expiration date for the use of the priority slot by the other communication station when allocating its own priority slot to other communication station.

27. The wireless communication method as cited in claim 20, wherein;
said priority slot borrowing step uses the priority slot of the other communication station in response to the release or the allocation of its own priority slot by the other communication station.

28. The wireless communication method as cited in claim 20, further comprising:
said priority slot returning step for releasing or returning the using priority slot borrowed at said priority slot borrowing step to the other communication station.

29. The wireless communication method as cited in claim 28, wherein;
said priority slot returning step releases the using priority slot of other communication station in response to a fact that the its own data transmission is completed.

30. The wireless communication method as cited in claim 28, wherein;
said priority slot returning step returns the priority slot to other communication station in response to a fact that it becomes the end of the expiration date for the use of the priority slot which is set when the priority slot of other communication station is allocated to its own, or in response to a request of the return of the priority slot from the other station.

31. A computer program described in a computer readable form to perform wireless communication processes on a computer system operating under a wireless communication environment, in which communication stations do not have relations such as a control station and a station to be controlled, said computer program comprising the steps of:
a priority slot acquisition step of acquiring a priority slot with which each communication station itself performs data transmission preferentially at predetermined time intervals under the above-mentioned wireless communication environment;
a priority slot lending step of releasing its own priority slot or allocating it to another communication station; and
a priority slot borrowing step of using the priority slot of another communication station.
